(19) United States
(12) Patent Application Publication
(10) Pub. No.: US 2022/0056381 A1
(43) Pub. Date: Feb. 24, 2022

(54) AQUEOUS CLEANING SOLUTION FOR REMOVAL OF ROUGING DEPOSITS ON MEDIA-CONTACTED SURFACES OF STAINLESS STEELS, USE THEREOF AND PROCESS FOR PRODUCTION THEREOF

(71) Applicant: Beratherm AG, Pratteln (CH)

(72) Inventors: Alexander Pohl, Buchenbach (DE); Gunter Rolf BLUMHOFER, Weil am Rhein (DE); Michael Hugo GOEBEL, Basel (CH)

(21) Appl. No.: 17/390,977

(22) Filed: Aug. 1, 2021

Related U.S. Application Data
(63) Continuation of application No. 15/753,333, filed on Aug. 15, 2018, now abandoned.

(30) Foreign Application Priority Data
Aug. 19, 2015 (EP) 15181647.7

(51) Int. Cl. C11D 7/26; C11D 11/00; C11D 7/06; C11D 7/10; C23G 1/08; C23G 1/02

(52) U.S. Cl. CPC C11D 7/265; C11D 11/0029; C23G 1/02; C11D 7/10; C23G 1/088; C11D 7/06

(57) ABSTRACT

An aqueous cleaning solution for removing rouging deposits on media-contacted surfaces of stainless steels comprises a first component and a second component. The first component is an alkali sulfite and the second component is an alkali formate, wherein the concentrations thereof are adjusted in such manner that formate is present in a molar ratio of 1.5 to 4.2 relative to sulfite, and that the pH value of the cleaning solution is 4.0 to 4.8. For preparing the aqueous cleaning solution, an aqueous solution of an alkali hydroxide is provided initially, thereafter a first amount of concentrated aqueous formic acid is admixed in an excess in such manner that a pH value of 3.5 to 4.5 is established, then a second amount of solid alkali sulfite is admixed in accordance with the sulfite concentration to be established, thus resulting in a pH value of 5.5 to 6.5, and finally a third amount of concentrated aqueous formic acid is admixed until a pH value of 4.0 to 4.8 is attained.

### CROSS REFERENCE TO RELATED APPLICATIONS

This is a continuation of U.S. patent application Ser. No. 15/753,333, which is the US national stage entry of international patent application no. PCT/EP2016/069742, filed Aug. 19, 2016 claiming priority to European patent application no. EP15181647.7, filed Aug. 19, 2015, wherein the above mentioned applications are incorporated herein by reference in their entireties.

### FIELD OF THE INVENTION

The present invention relates to an aqueous cleaning solution for removing rouging deposits on media-contacted surfaces of stainless steels according to the preamble of claim 1. Moreover, the invention relates to a use of the cleaning solution of the present invention and also to a process for preparation thereof.

### BACKGROUND OF THE INVENTION

Numerous devices of the pharmaceutical and biotechnological industry as well as of the food industry require pipe systems for pure or ultrapure water or ultrapure steam, which are usually made of austenitic stainless steels. In this context, it is generally known that the media-contacted inner surfaces of such systems, which are usually tempered systems, will develop, after an operating time of several weeks to months, a yellow, red to black-violet, often reddish-brown to rust-colored surface discoloration, which is referred to in technical terms as “rouging”. The main constituents of rouging are various iron oxides and iron hydroxides comprising iron in the oxidation state +3, which may also contain amounts of chromium, nickel and molybdenum. The rouging layers are detectable not only visually but also, for example, by means of an established white cloth wipe test, and they can be wiped off more or less easily depending on the particular manifestation. The rouging layers can result in contamination of downstream systems by spreading of the layer particles and thus are highly undesirable already for this reason alone. Accordingly, the removal of rouging deposits, also called “derouging”, is an important aspect of the maintenance of the aforementioned piping systems and the like. Thereby, it is crucial that the rouging deposits be removed in a useful time span and as completely as possible without damaging the surface, particularly any electropolished parts thereof.

Various derouging processes are already known which generally include the treatment of media-contacted inner surfaces with a suitable cleaning solution. In general, a distinction is made between acidic and pH-neutral derouging processes. However, it has been recognized quite some time ago that the use of concentrated mineral acids such as sulfuric acid and hydrochloric acid for derouging is associated with various disadvantages. In particular, their handling during transport as well as during application involves considerable danger due to the corrosive and caustic properties. Accordingly, various efforts have been made to develop derouging agents that are effective in the pH neutral range.

For example, U.S. Pat. No. 4,789,406 (Holder) describes a derouging process in the pH range of 6.5 to 7.5, in which the affected surface is initially pretreated with an organic reducing agent/complexing agent and subsequently treated in succession with an inorganic reducing agent, an inorganic wetting agent and finally with rinsing water.

WO 2009/095475 A1 (Ateco) also describes the use of an aqueous neutral cleaning solution for removing rouging deposits on stainless steels. In this case, a cleaning solution is proposed which contains a reducing agent and at least one complexing agent.

Further developments in the field of pH neutral derouging are described in a review article by G. Henkel and B. Henkel (G. Henkel und Benedikt Henkel, “Derouging von austenitischen Edelstahloberflächen mittels pH-neutraler Hochleistungschemikalien”, TechnoPharm. 1, Nr. 1, 2011. 46-53).

Numerous derouging agents that are either acid-based or quasi-neutral are now available on the market which indeed work well for certain applications but do not achieve the desired cleaning effect in certain other situations. Moreover, some disadvantages have been found to some extent during practical application:
high risk potential for humans and the environment due to the use of significantly toxic substances (see also relevant safety data sheets);
complicated handling (need for overlaying with N₂ gas, smell problems, requirements for preparing the mixture or ingredients at the intended place of use, costly monitoring of the cleaning process);
expensive chemicals.

In view of this situation, there is still a substantial need for efficient, cost-effective, easy-to-handle and particularly also environmentally harmless derouging processes or derouging agents, respectively.

### DESCRIPTION OF THE INVENTION

Therefore, it was an object of the present invention to provide an improved aqueous cleaning solution for removing rouging deposits on media-contacted surfaces of stainless steels. Further objects of the invention are the specification of a use or a process for preparing the cleaning solution of the present invention.

The above mentioned objects are achieved according to the present invention by means of the aqueous cleaning solution according to claim 1, by the use thereof according to claim 5 and by the preparation process according to claim 7.

Advantageous embodiments of the invention are defined in the dependent claims.

The aqueous cleaning solution for removing rouging deposits on media-contacted surfaces of stainless steels according to the present invention comprises a first component and a second component, wherein the first component is an alkali sulfite and the second component is an alkali formate, and wherein the concentrations thereof are adjusted in such manner that formate is present in a molar ratio of 1.5 to 4.2 relative to sulfite, and that the pH value of the cleaning solution is 4.0 to 4.8 (claim 1). Thereby, the first component acts as a complexing reducing agent and the second component acts as a buffering agent.

In one embodiment, formate is present in a molar ratio of 1.5 to 2.5 relative to sulfite and the pH value of the cleaning solution is 4.3 to 4.7.

In an advantageous embodiment, formate is present in a molar ratio of 3.0 to 4.2 relative to sulfite and the pH value of the cleaning solution is 4.1 to 4.5 (claim 2).

In general, the alkali sulfite can be any compound of the formula M₂SO₃ and the alkali formate can be any compound of the formula HC(O)OM, wherein M denotes any one of the non-radioactive alkali metals (Li, Na, K, Rb, Cs). However, for practical and economic reasons, only sodium (Na) and potassium (K) are relevant. The term “corresponding” in connection with alkali compounds shall be understood as meaning that all of the mentioned alkali compounds comprise the same alkali metal.

In particular, it has proven to be advantageous to use consistently sodium, i.e. sodium sulfite is used as the alkali sulfite and sodium formate is used as the alkali formate (claim 3). Na₂SO₃ is one of the sulfites that are used in the food industry as a food additive. Na₂SO₃ is approved under European approval number E 221 in the class of additives including antioxidants and preservatives.

The proportions of the individual components in the aqueous cleaning solution are to be chosen in such manner that formate is present in a molar ratio in the range of 1.5 to 4.2 relative to sulfite, and in particular about 3.0 to 4.2. Moreover, the pH-value of the cleaning solution shall be adjusted to a value in the range of 4.0 to 4.8, in particular to a pH 4.1 to 4.5. This ensures that the electrochemical potential of the solution is kept stable in the range of −225 to −320 mV. A negative potential of this magnitude means that a sufficiently strong reduction effect is present for the desired derouging effect. It has been found that the optimum pH-value depends somewhat on the type of process: for a dipping process a pH of about 4.5 is preferred whereas for a spraying process a somewhat lower pH of about 4.1 is advantageous.

It has been surprisingly found that with the above defined combination of features a highly effective derouging solution for media-contacted surfaces of stainless steels can be provided and that such solution is also capable of removing rust deposits on surfaces of unalloyed and low-alloyed steels. As will be explained in more detail below, this derouging solution consists of environmentally compatible and inexpensive substances.

Without being bound to a particular theory, it can be assumed that in the course of the derouging process the following reactions are relevant:

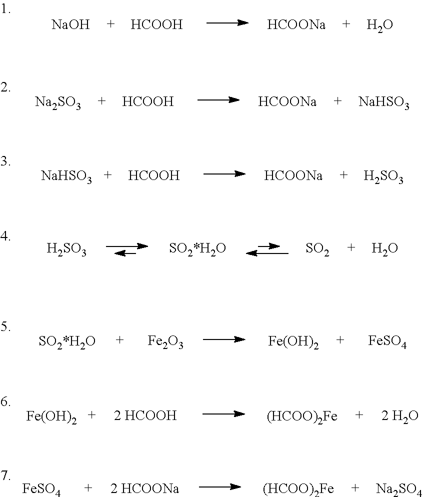

Reactions 1 to 3 initially lead to formation of sulfurous acid. Thereafter, sulfurous acid decomposes according to the reaction system 4 so as to form the gas hydrate form SO₂*H₂O, which is well soluble at room temperature and thus prevails in an equilibrium system. Subsequently, the actual derouging process is based on the reduction of iron (III) to iron (II) and the associated oxidation of sulfur (IV) to sulfur(VI) according to reaction 5 and on the following dissolution of the resulting iron(II)hydroxide by the action of formic acid according to reaction 6 and of sodium formate according to reaction 7.

Actually, sulfites release small amounts of sulfur dioxide (SO₂) under very acidic conditions. However, this is known to be a harmless compound at low concentrations and is actually used in the food industry as a preservative, antioxidant and disinfectant.

A further aspect of the invention relates to a use of the cleaning solution of the present invention for removing rouging deposits on media-contacted surfaces of stainless steels selected from the group of chromium/nickel and chromium/nickel/molybdenum steels (claim 5).

In certain situations, the rouging deposits can be removed by means of the cleaning solution of the present invention already at room temperature. In other situations, however, it is necessary to operate at an elevated temperature, which however should not exceed approximately 80° C. both for safety reasons and for avoiding a rapid loss of effect due to evaporating formic acid.

In general, the cleaning solution can be effectively used in a very broad concentration range. In particular, the sulfite concentration can be in the range of 0.05 to 1.5 mol/kg (claim 4). At comparatively low concentrations a longer exposure time is usually required, whereas at excessively high concentrations some solubility problems can occur. Accordingly, in an advantageous embodiment the sulfite concentration is 0.1 to 1 mol/kg, preferably 0.3 to 0.5 mol/kg.

According to an advantageous embodiment, the aqueous cleaning solution is used for removing rouging deposits with a layer thickness of 0.1 μm to 10 μm (claim 6).

The cleaning solution of the present invention can generally be prepared by adding the required amounts of alkali sulfite and alkali formate to a starting amount of water and adjusting the pH to the required value in a generally known manner. In particular, the pH-value can be adjusted by addition of formic acid and/or of an alkali hydroxide.

In contrast, for the preparing process of the present invention (claim 7) an aqueous solution of an alkali hydroxide is provided initially and thereafter a first amount of concentrated aqueous formic acid is admixed as an excess in such manner that a pH-value of 3.5 to 4.5 is established. Then, a second amount of a solid alkali sulfite is admixed in accordance with the sulfite concentration to be established, thus resulting in a pH value of 5.5 to 6.5, and finally a third amount of concentrated aqueous formic acid is admixed until a pH value of 4.0 to 4.8 is attained. As already mentioned, the optimum pH depends somewhat on the type of process: in the dipping process, a pH of about 4.5 is preferred, while in the spraying process a somewhat lower pH of about 4.1 is advantageous.

The term “concentrated aqueous formic acid” is to be understood in the present case as an aqueous solution of formic acid having a concentration of at least 50 to about 95 wt.-%. If necessary, such solution can be prepared from highly concentrated, i.e. approximately 100% formic acid.

The sequence of addition steps is mandatory in view of side reactions of SO₃²⁻ and in view of the solubility of the various components. It will be understood that the addition of the alkali hydroxide and of formic acid according to the preparing process of the present invention corresponds to the apparently simpler addition of alkali formate. However, it has been found that the method according to the present invention is comparatively inexpensive and simple for carrying out the preparing process.

Moreover, it will be understood that the relative amounts of dissociated and of non-dissociated formic acid, respectively, depend on the pH-value of the solution.

Although the preparing process can be carried out with various alkali hydroxides, sodium hydroxide (NaOH) is the preferred one (claim 8). It is particularly advantageous if the initially provided aqueous solution of sodium hydroxide has a concentration of 0.9 to 1.1 mol/kg and if the added aqueous formic acid has a concentration of 80 to 100 wt.-%, preferably about 85 wt.-% (claim 9).

In principle, the ready-to-use cleaning solution can be prepared in advance and stored as stock solution, in which case heating of the cleaning solution, for example by solar radiation, is to be avoided in order to avoid an undesired loss of effectiveness. According to an advantageous embodiment, however, the admixture of the third amount is carried out immediately before use (claim 10). In this way the comparatively complex mixing of alkali hydroxide and formic acid and the subsequent addition of alkali sulfite can be carried out in a suitable working environment, with the precursor prepared in this manner being readily storable as a non-hazardous substance. The final preparation of the cleaning solution can then be carried out immediately before use and preferably on site.

It will be understood that for practical implementation the present and the following specifications in mol or mol/kg can be converted to weights or weight concentrations by taking into account the molecular weights of the respective species.

### EXEMPLARY EMBODIMENTS

In the following, two different ways for preparing an aqueous cleaning solution for removing rouging deposits on media-contacted surfaces of stainless steels are presented. In both cases, a batch resulting in 100 kg of ready-to-use solution with 4 wt.-% NaOH is described.

### Example 1: Addition of 50% NaOH Solution

79 kg water are provided and thereafter 8 kg of a 50 wt.-% aqueous NaOH solution (sodium hydroxide solution) are added thereto. Thereafter, 7 kg of 85 wt.-% aqueous formic acid are gradually added while stirring, whereupon a pH-value of approximately 4 is reached with a concomitant increase in temperature to 35° C. Subsequently, 5 kg of solid sodium sulfite (Na₂SO₃) are added, whereupon a pH-value of approximately 6 is established. Finally, further 1 to 2 kg aqueous formic acid (HCOOH 85%) are added, the addition being metered in such manner that a pH-value of 4.5 to 4.1 (depending on the type of process, see example 4) is established. The cleaning solution thus obtained should have an electrochemical potential of −50 to −350 mV.

### Example 2: Addition of NaOH-Pellets

81 kg water are provided and thereafter 4 kg of caustic soda 98 to 100 wt.-% in pellets are added thereto. The resulting solution is stirred until all the NaOH is dissolved. Thereafter, 7 kg of 85 wt.-% aqueous formic acid are gradually added while stirring, whereupon a pH-value of approximately 4 is reached with a concomitant increase in temperature to 35° C. Subsequently, 5 kg of solid sodium sulfite (Na₂SO₃) are added, whereupon a pH-value of approximately 6 is stablished. Finally, further 1 to 2 kg aqueous formic acid (HCOOH 85%) are added, the addition being metered in such manner that a pH-value of 4.5 to 4.1 (depending on the type of process, see example 4) is established. The cleaning solution thus obtained should have an electrochemical potential of −50 to −350 mV.

### Example 3: Preparation of a Precursor with Improved Storability

In a batch according to example 1 or 2, the solution with a pH-value of about 6 obtained after addition of sodium sulfite is stored in suitable containers as a precursor. Immediately before the cleaning process, the required amount of precursor is weighted on site and thereafter the required amount of aqueous formic acid for adjusting the pH-value of 4.5 to 4.1 (depending on the type of process, see example 4) is admixed. This completes preparation of the ready-to-use cleaning solution.

### Example 4: Derouging-Process

For removing rouging deposits by means of a dipping process, a cleaning solution with a pH=4.5 is used preferably, whereby an exposure time of 2 hours should be scheduled in case of a treatment temperature of 70° C. whereas an exposure time of 1 hour should be scheduled in case of a treatment temperature of 80° C.

For removing rouging deposits by means of a spraying process, a cleaning solution with a pH=4.1 is used preferably, whereby an exposure time of 4 hours should be scheduled in case of a treatment temperature of 70° C. whereas an exposure time of 2 hours should be scheduled in case of a treatment temperature of 80° C.

1. An aqueous cleaning solution comprising:
a first component and a second component,
wherein the first component is an alkali sulfite and the second component is an alkali formate,
wherein the concentrations of the first component and second component are adjusted such that formate is present in a molar ratio of 1.5 to 4.2 relative to sulfite, and that the pH value of the cleaning solution is 4.0 to 4.8,
wherein the aqueous cleaning solution is adapted to remove rouging deposits on media-contacted surfaces of stainless steels.

2. The aqueous cleaning solution according to claim 1, wherein the molar ratio of formate relative to sulfite is 3.0 to 4.2 and the pH value of the cleaning solution is 4.1 to 4.5.

3. The aqueous cleaning solution according to claim 1, wherein the alkali sulfite is sodium sulfite and the alkali formate is sodium formate.

4. The aqueous cleaning solution according to claim 1, wherein the sulfite is present in a concentration of 0.05 to 1.5 mol/kg.

5. Method for removing rouging deposits on media-contacted surfaces of stainless steels comprising:
providing the aqueous cleaning solution of claim 1,
contacting the aqueous cleaning solution with said media-contacted surfaces,
wherein said media-contacted surfaces are selected from the group of chromium/nickel and chromium/nickel/molybdenum steels.

6. The method according to claim 5, wherein the rouging deposits have a layer thickness of 0.1 μm to 10 μm.

7. A process for preparing an aqueous cleaning solution according to claim 1 comprising:
providing initially an aqueous solution of an alkali hydroxide, subsequently admixing a first amount of concentrated aqueous formic acid in excess such that a pH-value of 3.5 to 4.5 is established,
subsequently admixing a second amount of solid alkali sulfite in accordance with the sulfite concentration to be established in the aqueous cleaning solution, thus resulting in a pH value of 5.5 to 6.5, and
finally admixing a third amount of concentrated aqueous formic acid until a pH value of 4.0 to 4.8 is attained.

8. The process according to claim 7, wherein the alkali hydroxide is sodium hydroxide and the alkali sulfite is sodium sulfite.

9. The process according to claim 8, wherein the initially provided aqueous sodium hydroxide solution has a concentration of 0.9 to 1.1 mol/kg and the admixed aqueous formic acid has a concentration of 80 to 100 wt.-%.

10. The process according to claim 7, wherein the admixing of the third amount is carried out immediately before use.

11. The aqueous cleaning solution according to claim 2, wherein the alkali sulfite is sodium sulfite und the alkali formate is sodium formate.

12. The aqueous cleaning solution according to claim 2, wherein the sulfite is present in a concentration of 0.05 to 1.5 mol/kg.

13. The aqueous cleaning solution according to claim 3, wherein the sulfite is present in a concentration is 0.05 to 1.5 mol/kg.

14. The aqueous cleaning solution according to claim 4, wherein the sulfite is present in a concentration is 0.1 to 1 mol/kg

15. The aqueous cleaning solution according to claim 4, wherein the sulfite is present in a concentration is 0.3 to 0.5 mol/kg.

16. The method according to claim 5, wherein the molar ratio of formate relative to sulfite is 3.0 to 4.2 and the pH value of the cleaning solution is 4.1 to 4.5.

17. The method according to claim 5, wherein the alkali sulfite is sodium sulfite und the alkali formate is sodium formate.

18. The process according to claim 9, wherein the admixed aqueous formic acid has a concentration of about 85 wt.-%.

19. The process according to claim 8, wherein the admixing of the third amount is carried out immediately before use.

20. The process according to claim 9, wherein the admixing of the third amount is carried out immediately before use.
